(19) United States
(12) Patent Application Publication
(10) Pub. No.: US 2022/0174503 A1
(43) Pub. Date: Jun. 2, 2022

(54) TELECOMMUNICATION MAP LABEL VERIFICATION

(71) Applicant: AT&T Intellectual Property I, L.P., Atlanta, GA (US)

(72) Inventors: Velin Kounev, Weehawken, NJ (US); Yaron Kanza, Fair Lawn, NJ (US); Arun Jotshi, Parsippany, NJ (US)

(21) Appl. No.: 17/105,951

(22) Filed: Nov. 27, 2020

(51) Int. Cl. H04W 16/18; G06Q 10/08; G06N 20/00; H04W 24/02

(52) U.S. Cl. CPC H04W 16/18; H04W 24/02; G06N 20/00; G06Q 10/087

(57) ABSTRACT

A processing system may obtain a map comprising a plurality of geographical objects, identify a first label of a first geographical object that identifies a first geographical object type, identify a second label of a second geographical, identify a geospatial relationship between the first and second geographical objects, and apply an input data set comprising geospatial relationship information of the first geographical object to a geospatial relationship model to obtain an output comprising a confidence factor of the first label of the first geographical object. The geospatial relationship model may be associated with the first geographical object type and is to output the confidence factor based upon the input data set. The input data set may include the geospatial relationship between the first and second geographical objects. The processing system may then apply at least one modification to the map based upon the confidence factor.

The present disclosure relates generally to telecommunication network operations, and more particularly to methods, computer-readable media, and apparatuses for applying an input data set comprising geospatial relationship information of a first geographical object to a geospatial relationship model to obtain an output comprising a confidence factor of a first label of the first geographical object in a map and applying at least one modification to the map based upon the confidence factor.

### BRIEF DESCRIPTION OF THE DRAWINGS

The teachings of the present disclosure can be readily understood by considering the following detailed description in conjunction with the accompanying drawings, in which:

FIG. 1 illustrates an example system related to the present disclosure;

FIG. 2 illustrates an example map relating to examples of the present disclosure for applying an input data set comprising geospatial relationship information of a first geographical object to a geospatial relationship model to obtain an output comprising a confidence factor of a first label of the first geographical object in a map and applying at least one modification to the map based upon the confidence factor;

FIG. 3 illustrates a flowchart of an example method for applying an input data set comprising geospatial relationship information of a first geographical object to a geospatial relationship model to obtain an output comprising a confidence factor of a first label of the first geographical object in a map and applying at least one modification to the map based upon the confidence factor; and

FIG. 4 illustrates a high level block diagram of a computing device specifically programmed to perform the steps, functions, blocks and/or operations described herein.

To facilitate understanding, identical reference numerals have been used, where possible, to designate identical elements that are common to the figures.

### DETAILED DESCRIPTION

In one example, the present disclosure describes a method, computer-readable medium, and apparatus for applying an input data set comprising geospatial relationship information of a first geographical object to a geospatial relationship model to obtain an output comprising a confidence factor of a first label of the first geographical object in a map and applying at least one modification to the map based upon the confidence factor. For example, a processing system having at least one processor may obtain a map comprising a plurality of geographical objects, identify a first label of a first geographical object of the plurality of geographical objects, where the first label identifies a first geographical object type, identify a second label of at least a second geographical object of the plurality of geographical objects, and identify a geospatial relationship between the first geographical object and the second geographical object. The processing system may next apply an input data set comprising geospatial relationship information of the first geographical object to a geospatial relationship model to obtain an output comprising a confidence factor of the first label of the first geographical object. The geospatial relationship model may be associated with the first geographical object type and is to output the confidence factor based upon the input data set comprising the geospatial relationship information of the first geographical object. The input data set may include at least the geospatial relationship between the first geographical object and the second geographical object having the second label. The processing system may then apply at least one modification to the map based upon the confidence factor of the label of the first geographical object.

In one example, the present disclosure enhances the recognition of geographical objects (map objects) and validates geographical object labels where source image quality is low. For example, when trying to recognize utility poles from satellite or other aerial images, which are narrow and hard to detect using low-quality images, error detection via geospatial patterns may increase the recognition/labeling accuracy and improve efficiency of error detection and correction in comparison to traditional use of machine learning (ML)-based detection/recognition models. In one example, the present disclosure validates the results of ML-based object recognition and labeling of geographical objects automatically by using other geospatial characteristics of the environment, such as learning that a cell tower in the middle of a lake or a pond may be a labeling error and/or a detection/recognition error. Examples of the present disclosure may also verify map labels of geographical objects from other sources, such as human-added labels of one or more geographical objects, labels obtained from an equipment inventory database that stores asserted geographic locations of different equipment items, and so forth.

In ML-based map enrichment a goal may be to detect geospatial/geographical objects and add markers (e.g., polygons, labels) to the map by using computer vision and ML tools (e.g., neural networks). The enrichment process may include detecting and adding geographical objects like buildings, utility poles, antenna towers, etc. Detecting geospatial objects, such as utility poles based on satellite images is often difficult because the footprint (shape from a bird's eye view) is small. Some objects are not easy to detect due to their similarity to other objects. In some cases it is beneficial to discover the type of a building or gain semantic information about discovered objects (e.g., learn that a building is a school, distinguish between a small park and a baseball field, etc.).

The present disclosure utilizes geospatial relationships of geographical objects to improve the efficiency and the accuracy of object discovery and map enrichment. For instance, in one example, geospatial relationships may be used as integrity constraints, e.g., if a building is discovered in the middle of a lake or in the middle of the road, it is more likely that there is a classification error.

Geospatial relationships that may be used to determine classification errors (or to increase confidence of correct labeling/classification) may include proximity or correlation of a geographical object to other geographical objects. For instance, utility poles are generally found near roads. A single pole in the middle of a forest or a field (far from any road) may be more likely to be a detection error. Similarly, train stations are most often adjacent to railroad tracks, a large building near the railroad tracks would be a candidate for a train station, while a building far from the railroad tracks is less likely to be a train station. In another example, a building having many police cars in its parking lot is likely to be a police station. Conversely, if there are no police cars, it is less likely that the building is a police station. A large playground adjacent to a large building will increase the likelihood that the building is a school or a daycare center, in comparison to buildings without an adjacent playground. In one example, geospatial relationships may include geospatial patterns to further the confidence of geographical object detection/recognition. For instance, if utility poles appear as a sequence of geospatial objects along roads and railroads (e.g., with an average gap of 125 feet between adjacent poles), this information could be used to verify locations of additional utility pole in the sequence, once initial poles have been confirmed (or to detect the location(s)/position(s) of one or more utility poles that are not yet discovered).

In one example, the present disclosure may be applied in real time to create temporally evolving maps (e.g., to present changes over time) and/or real-time maps which present moving objects on the map (e.g., with updates to the map when the objects move). In one example, geospatial relationships and constraints may be similarly applied to the moving objects. For instance, it is more likely to see moving cars in a place where there is a road than in a place where there is no road. A moving object over a body of water is more likely to be a boat than a car, etc. In one example, the present disclosure may also qualify detection results in a probabilistic manner. For instance, each geographical object may be assigned a likelihood score, or “confidence score,” that will indicate how likely that the detection is correct. Constraints based upon geospatial relationships (e.g., a confidence factor) may then increase or decrease the likelihood of each detection (e.g., the confidence score). Accordingly, users of the map may choose to ignore geographical objects with a low likelihood/confidence score, depending upon the particular use case. Alternatively, or in addition, where the confidence score is below a threshold after applying a modification based upon the confidence factor (e.g., determined from geospatial relationship(s)), a label of a geographical object may be removed from the map.

Thus, the learned information can be used to discover geographical objects that are useful or necessary for network planning. Examples of the present disclosure may also be applied to other map enrichment tasks where there is a need to discover geospatial objects from satellite and street view images and add these objects to an enriched map.

A telecom-oriented map may be used to assist decision making in telecommunication network operations and to facilitate the design and planning of telecommunication networks. A telecom-oriented map may comprise a multi-layer map that encapsulates the geospatial environment, network components, network usage patterns, and potential changes in the network. It helps viewing and evaluating a network from a variety of perspectives, including efficiency, resilience, flexibility, scalability, and interoperability. In one example, a telecom-oriented map provides a holistic view of the information related to network planning and operation. Telecommunication networks are complex and dynamic. They include many different components, both wireline and wireless, with different capabilities and restrictions. Some network components are affected by the geospatial environment, e.g., cellular antennas have a limited range and cover only a limited area. High-frequency transmissions like millimeter waves and microwaves are affected by obstacles in the environment.

Shorter frequencies (e.g., microwaves and millimeter waves for 5G wireless transmissions) are highly affected by obstacles like buildings, trees and the terrain—much more than electromagnetic transmissions with a longer wavelength. In addition, in a network function virtualization (NFV) architecture, virtual network functions (VNFs) are deployed on virtual machines in a flexible way that allows functions to be adapted to the network demand and react to changes in network traffic. A telecom-oriented map connects the VNFs with the geospatial features that affect the needs for VNFs. Thus, a telecom-oriented map may be used for network planning, such as making decisions regarding the location of cellular antennas, fibers and towers, in order to create the backhaul, including short and long-haul links, resource allocation like dedicated network switches, routers, transmitters, receivers, etc. In the case of a long-haul link, for example, the decision whether to deploy a fiber or use a wireless microwave transmission between towers could depend on the geospatial conditions in the area. Some obstacles like tall buildings or mountains may prevent the use of a microwave link, while deep canyons could be problematic for the deployment of fiber links.

A telecom-oriented map may be used for network operations, such as shifting resources from one location to another to cope with local changes in demand. Taking geospatial restrictions into account may improve resource allocation decision making and the effectiveness of any implemented change, e.g., when deploying one or more portable cell towers (e.g., a Cell on Wheels or (CoW)). A telecom-oriented map may also be used in resilience testing. To examine the robustness of the network to environmental changes, it may be helpful to have a view of the network components and their connections with the environment.

In one example, a telecom-oriented map is a multi-layer map where each layer represents a different aspect of the network or features that affect the network. In one example, the map may include a geospatial layer. For example the geospatial layer may include the geographical objects in the environment, e.g., terrain information, buildings, trees, etc. The geographical objects may be represented by polygonal shapes with location, material, and height. Note that height information may provide a 3D view of the environment. The location of each node may be represented by a pair of longitude/latitude coordinates. Complex objects can be constructed by a set of polygonal shapes with different heights. This layer may provide information about the height and material of buildings, trees, and other obstacles to network transmissions, e.g., obstacles that may cause an interference to microwave transmissions between communication towers. The material of buildings may also be included as information relevant to the reflection, penetration, and refraction of electromagnetic waves, e.g., cellular waves may be affected more by thick concrete walls than by thin glass exterior.

The telecom-oriented map may further include a network components layer that contains information about network-related structures and devices, like communication towers, antennas, fibers, data centers, switches, etc. For antennas, the information may contain the range. For a directional antenna, the information may further contain the direction of the antenna, the antenna tilt, and the sector that it covers. For physical machines like switches, the information may contain their physical locations—the data center(s) where they are managed and the location(s) in the data center(s). Fibers may be represented by polylines. Data centers and towers may be represented by polygonal shapes. The telecom-oriented map may further include a network function virtualization (NFV) layer that represents virtual machines and VNFs, and that represents the association of these virtual components to the geospatial environment. For example, suppose that a virtual switch Vₛ is executed by a virtual machine that is deployed on a physical server S. Then, Vₛ is associated with the physical (geographic) location of physical server S.

The telecom-oriented map may further include a dynamic and static usage layer that provides information about the network utilization in the form of statistical properties of different parameters, such as average network traffic in a switch or a tower, the number of cellular devices a cellular antenna (or tower) handles per time unit, the rate of cellular handoffs, network traffic at peak time, the rate of dropped calls/dropped packets per network component, etc. Thus, a telecom-oriented map such as described may be used to easily access all the information for a given area, including the geographical obstacles, network components, virtual network functions that serve the area, and data regarding the network traffic in that area.

In a telecom-oriented map, information is organized based on its association with geographical locations. Hence, information may be stored in a geospatial database (e.g., using PostGIS and/or PostgreSQL) with suitable geospatial indexes. A retrieval query may define a geospatial region and return all the information regarding this region, either from all the layers or from specific layers. This can be accomplished efficiently using spatial indexes. For network planning, a comprehensive view that presents the 3D geospatial entities, the physical network components and virtual resources, along with statistics and data that indicate potential network usage, help in selecting the most appropriate way to extend the network, e.g., where to add new cellular antennas based on statistics and the topography of the area, where to add fibers and where to add wireless links (such as how to connect communication towers and which towers to connect), decisions regarding switches, routers, and load balancing for routing of packets, selecting the direction and tilt of antennas based on a 3D view of the environment, and so on.

In another example, an enhanced view of NVF geospatial dependencies can support dynamic resource allocation, e.g., shifting network resources to an area with a high demand from an area with a lower demand, while taking geospatial considerations into account. For instance, suppose that at some hours there is a high demand for network resources in New York while there is lower demand in California. Allocating VNFs that are executed on servers in California to New York might not be an optimal solution because that may increase the load on some midway switches. Instead, it might be possible to shift resources as a sequence of migrations of VNFs between data centers, e.g., move resources from California to Colorado, then from Colorado to Illinois, etc., based upon the network view provided by the telecom-oriented map. In addition, for a resilience test, the advantage of the layered map is that the test can examine threats and effects on the physical and virtual network functions.

In any case, to create a telecom-oriented map, detailed descriptions are desirable of the environment, the network, and the different layers. In one example, a network operator may maintain information about the physical and virtual network components, e.g., in an inventory and/or equipment database, which may be plotted on a map layer or included in the map by geographic coordinates, or the like. The present disclosure may seek to enrich the map by adding relevant information about geographical objects. In one example, geographical maps, or map databases may be obtained from publicly available sources or commercial providers, some of which may include geographical object labels. In addition, these maps, or map databases may be combined with network operator inventory to provide a combined and/or layered map. However, in many instances, the existing map labels may be wrong. Some are applied by humans who may be unfamiliar with the actual area(s) for which the labels are applied, or mistakes may simply be made. In addition, many geospatial objects that are of importance to a network operator may not be labeled in the data obtained from a map provider/map data source, such as utility poles, large trees, etc. Similarly, inventory/equipment data sets may also contain errors, may be incomplete, or may have a low spatial accuracy. Thus, locations of inventory/equipment in the network operator records may not match precisely to a geospatial object in a map, or may match to an incorrect geospatial object on the map.

In one example, machine learning (ML)-classifiers, or geographical object detection models, may be used to detect geographical objects in satellite or aerial images. The classifiers may include convolutional neural network (CNN) classifiers, Fast-CNN classifiers, recurrent neural network (RNN) classifiers, and so forth. The following are examples of how classifiers/geographical object detection models can be used to enrich a telecom-oriented map. In one example, a classifier may be trained to detect the type of ground cover in different places (e.g., high buildings, low buildings, foliage (trees/bushes), etc.). The entire area of the map may be partitioned into bins shaped as squares, e.g., each bin with a size of 10 m×10 m. Different models may be applied to the bins for specifying the type of land cover (buildings, trees, etc.). Labels of the land cover type may then be added to the map. This may also help in estimating the height in places where height information is incomplete (e.g., for a Digital Surface Model (DSM)). In one example, a classifier may be trained to detect towers and tall structures based on imagery or shadows in aerial imagery, and other features. The classifier may be applied to the satellite and/ or aerial image(s). Any detected towers may then be labeled and added to the map. This may help in considering suitable places for new network access points, e.g., cell towers, antennas, etc. Similarly, a classifier may be trained to detect utility poles, street lights, and other structures suitable for antennas. The classifier(s) may be applied to the satellite and/or aerial image(s). Any detected structures may then be added to the map to assist in selection of suitable places for cellular antennas. ML-based classifiers may similarly be applied to detect tall buildings that might obstruct wireless transmissions, places where there are expected to be a high usage of network services, like train stations and other transportation hubs, department stores, schools, police stations, etc., and so forth.

It is again noted that the ability to create and maintain accurate, detailed maps may be a challenging task. For example, crowd sourcing projects like OpenStreetMap (OSM) contain only a small percentage of the buildings in the United States. Commercial maps are often incomplete when it comes to telecom-related information like communication towers, streetlights, utility poles, etc. Trees are also often not included in maps, but they sometimes obstruct wireless transmissions. Thus, existing map sources are not complete for telecommunication network operation and planning purposes.

Examples of the present disclosure further enhance the detection and recognition of geographical/geospatial objects based upon geospatial relationships between such geographical objects. For example, train stations are expected to be near railways, department stores in suburban areas often have a large parking lot, etc. Hence, to assist detection and improve the accuracy of ML-based classifiers (or to verify the accuracy of human-added labels/classifications), geospatial relationships (e.g., proximity, correlation, or geospatial patterns) between geographical objects of different types (or multiple instances of a same type of geographical object) are learned and used in the detection/recognition process, or may be applied after the fact for verification of existing labels/classifications. In one example, different geospatial/geographical objects are first detected and added to the map with the appropriate labels. As explained above, this may be accomplished using different classifiers that were trained to detect different types of objects: buildings, towers, utility poles, trees, etc. Alternatively, or in addition, a map may be obtained with ML-added and/or human-added labels. Then, a ML-based model, e.g., a “geospatial relationship model” may be trained for each type of geographical object to learn geospatial relationships of instances of a given type of geographical object with other instances of different types of geographical objects (and/or other instances of the same type of geographical object). Using this model, potential false positive classifications (e.g., a train station that is not near any railway) and potential false negative classifications (e.g., a building adjacent to the railway and near a large parking lot that is not classified as a possible train station) may be identified. Because the resultant map may be used for impactful network operations and network planning actions, the detection of classification errors is important.

In one example, the present disclosure may train a geospatial relationship model with a plurality of training examples, each of the plurality of training examples comprising geospatial relationship information for a respective one of a plurality of instances of a geographical object type, e.g., a first geographical object type. The training data may be obtained from labeled parts of the map, from other/external maps, from aerial and/or satellite images, etc.

The geospatial relationship information may comprise co-occurrences of the instance of the first geographical object type with one or more instances of other geographical object types within a threshold distance from the instance of the first geographical object type (e.g., a building near train tracks is more likely to be correctly classified as a train station than a building that is not near train tracks, but lack of train tracks near stations may not lead to definitive conclusion that label is wrong, just a decreased confidence (for example, some city train stations have tracks that are underground for many blocks nearby)).

Other types of geospatial relationship information may comprise co-occurrences of the instance of the first geographical object type with one or more others of the plurality of instances of the first geographical object type within a threshold distance from the instance of the first geographical object type (e.g., if there are light poles in a parking lot, there are probably others nearby), co-occurrences of the instance of the first geographical object type with one or more instances of other geographical object types contiguous to the instance of the first geographical object type (e.g., a cell tower is often accompanied by a shed with a generator, base station equipment, etc.), co-occurrences of the instance of the first geographical object type with one or more others of the plurality of instances of the first geographical object type contiguous to the instance of the first geographical object type (e.g., if there are trees, then it is likely that there are more trees nearby), and so forth. In one example, the geospatial relationship information may further comprise distances relating to some or all of the above types of geospatial relationship information. In one example, geospatial relationship information may also comprise, for at least one instance of the plurality of instances of the first geographical object type, a geospatial pattern of the at least one instance together with other instances of the plurality of instances of the first geographical object type. This could include a repeating pattern on the map and/or in aerial images, e.g., evenly spaced light poles, power lines, etc., (e.g., in a linear, or substantially linear pattern). In one example, this type of geospatial pattern may further comprise a co-occurrence of at least one instance of at least one other geographical object type with the repeating pattern in the map. For instance, light poles spaced at regular intervals along a road, power lines spaced evenly along a fire cut/gap in the forest, at regular intervals coincident with train tracks, etc., may be considered as a geospatial relationship.

All of these types of geospatial relationships may be discovered in portions of the map that are already labeled. Thus, the present disclosure may obtain a representative number of samples of instances of the first type of geographical object. For each such instance, the present disclosure may search for geospatial relationships within a threshold distance or distances, e.g., for co-occurrences, within 5 miles, for geospatial patterns, up to 50 miles, etc. These relationships may be collected via queries on the map (e.g., a map database). For instance, the map may be stored and maintained, and may be queryable in accordance with PostGIS and/or PostgreSQL. The querying may be automatic in accordance with examples of the present disclosure to search for particular types of geospatial relationships for each instance of the first geographical object type. Then, each instance may be used as a training example for the geospatial relationship model, where the geospatial relationships may comprise inputs/predictors, and a dependent variable/output may comprise a confidence factor which indicates a likelihood that the label is correct (e.g., is an instance of a geographical object of the first geographical object type, or not?).

The geospatial relationship model may comprise, for example, a deep neural network (DNN), e.g., a convolutional neural network (CNN), or the like. The number of layers, the number of cells per layer, and so forth may be set based upon a variety of considerations, such as a desired accuracy, computation time, etc. Alternatively, the geospatial relationship model may have a different form in accordance with the present disclosure, such as a support vector machine (SVM), e.g., a binary, non-binary, or multi-class classifier, a linear or non-linear classifier, and so forth. It should be noted that various other types of machine learning algorithms (MLAs) and/or machine learning models (MLMs) may be implemented in examples of the present disclosure, such as k-means clustering and/or k-nearest neighbor (KNN) classifier models, support vector machine (SVM)-based classifiers, e.g., a binary classifier and/or a linear binary classifier, a kernel-based classifier (e.g., a kernel-based SVM), etc., a distance-based classifier, e.g., a Euclidean distance-based classifier, or the like, and so on.

For instance, geospatial relationships of an instance of the first geographical object type may be represented as a vector or point in a feature space, and the confidence factor may be calculated based upon a distance of the vector/point to a separation hyperplane in the feature space (e.g., where the separation hyperplane may represent the cutoff between the first geographical object type and “not the first geographical object type”). In one example, the MLA may incorporate an exponential smoothing algorithm (such as double exponential smoothing, triple exponential smoothing, e.g., Holt-Winters smoothing, and so forth), reinforcement learning (e.g., using positive and negative examples after deployment as a MLM), and so forth.

In one example, the training may be supervised in that examples may be selected with known correct labels/classifications. However, in another example, the training may be unsupervised. In this case, there may be false positives or false negatives in the training data. However, with a large training data set/sample size, these may be subsumed by those that are correct. In this regard, it should be noted that once trained with a sufficiently large data set, the geospatial relationship model may also be applied to instances from the training data set to discover those that may be incorrectly labeled.

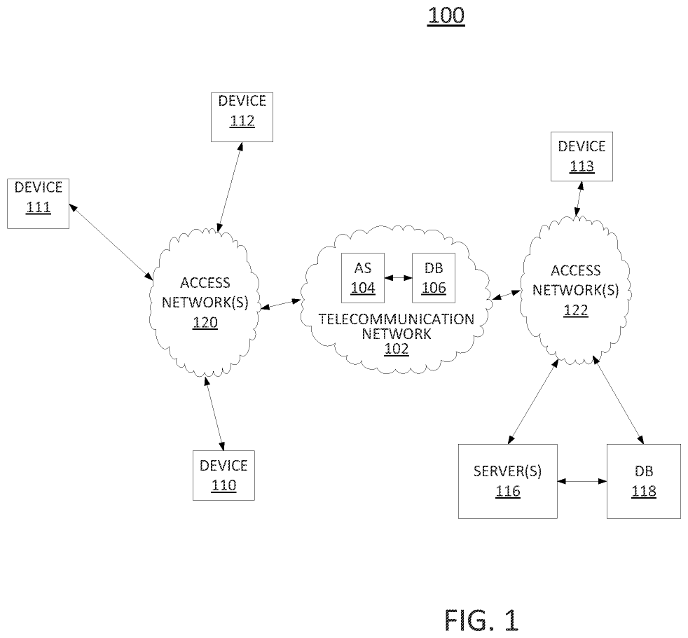

The trained geospatial relationship model may be applied to additional instances in the map where the first geospatial object type is detected/labeled. If the detection is via a ML-based classifier, there may be an existing confidence score output by the ML-based classifier. Then the confidence factor from the geospatial relationship model may be applied to modify the confidence score (e.g., an increase or decrease to the confidence score, depending upon the confidence factor). In another example, human-added labels may be given a default confidence score, e.g., 100 percent, 90 percent, etc. The confidence factor may then be used to modify such confidence score. In one example, human labelers may have different accuracy levels, which may be reflected in confidence scores assigned to labels added to the map or otherwise obtained from such human labelers. These and other aspects of the present disclosure are described in greater detail below in connection with the examples of FIGS. 1-4.

To aid in understanding the present disclosure, FIG. 1 illustrates an example system 100 in which examples of the present disclosure for applying an input data set comprising geospatial relationship information of a first geographical object to a geospatial relationship model to obtain an output comprising a confidence factor of a first label of the first geographical object in a map and applying at least one modification to the map based upon the confidence factor may operate. The system 100 may include any one or more types of communication networks, such as a circuit switched network (e.g., a public switched telephone network (PSTN)) or a packet network such as an Internet Protocol (IP) network (e.g., an IP Multimedia Subsystem (IMS) network), an asynchronous transfer mode (ATM) network, a wireless network, a cellular network (e.g., 2G, 3G, 4G, 5G and the like), a long term evolution (LTE) network, and the like, related to the current disclosure. It should be noted that an IP network is broadly defined as a network that uses Internet Protocol to exchange data packets. Additional example IP networks include Voice over IP (VoIP) networks, Service over IP (SoIP) networks, and the like.

In one example, the system 100 may comprise a telecommunication network 102. The telecommunication network 102 may be in communication with one or more access networks 120 and 122, and the Internet (not shown). In one example, telecommunication network 102 may combine core network components of a cellular network with components of a triple play service network; where triple-play services include telephone services, Internet services and television services to subscribers. For example, telecommunication network 102 may functionally comprise a fixed mobile convergence (FMC) network, e.g., an IP Multimedia Subsystem (IMS) network. In addition, telecommunication network 102 may functionally comprise a telephony network, e.g., an Internet Protocol/Multi-Protocol Label Switching (IP/MPLS) backbone network utilizing Session Initiation Protocol (SIP) for circuit-switched and Voice over Internet Protocol (VoIP) telephony services. Telecommunication network 102 may further comprise a broadcast television network, e.g., a traditional cable provider network or an Internet Protocol Television (IPTV) network, as well as an Internet Service Provider (ISP) network. In one example, telecommunication network 102 may include a plurality of television (TV) servers (e.g., a broadcast server, a cable head-end), a plurality of content servers, an advertising server, an interactive TV/video on demand (VoD) server, and so forth. For ease of illustration, various additional elements of telecommunication network 102 are omitted from FIG. 1.

In one example, the access networks 120 and 122 may comprise Digital Subscriber Line (DSL) networks, public switched telephone network (PSTN) access networks, broadband cable access networks, Local Area Networks (LANs), wireless access networks (e.g., an Institute for Electrical and Electronics Engineers (IEEE) 802.11/Wi-Fi network and the like), cellular access networks, 3^{rd} party networks, and the like. For example, the operator of telecommunication network 102 may provide a cable television service, an IPTV service, or any other types of telecommunication service to subscribers via access networks 120 and 122. In one example, the access networks 120 and 122 may comprise different types of access networks, may comprise the same type of access network, or some access networks may be the same type of access network and other may be different types of access networks. In one embodiment, the telecommunication network 102 may be operated by a telecommunication network service provider. The telecommunication network 102 and the access networks 120 and 122 may be operated by different service providers, the same service provider or a combination thereof, or may be operated by entities having core businesses that are not related to telecommunications services, e.g., corporate, governmental or educational institution LANs, and the like.

In one example, the access networks 120 may be in communication with one or more devices 110-112. Similarly, access networks 122 may be in communication with one or more devices, e.g., device 113. Access networks 120 and 122 may transmit and receive communications between devices 110-113, between devices 110-113, and components of telecommunication network 102, devices reachable via the Internet in general, and so forth. In one example, each of the devices 110-113 may comprise any single device or combination of devices that may comprise a user endpoint device. For example, the devices 110-113 may each comprise a mobile device, a cellular smart phone, a laptop, a tablet computer, a desktop computer, an application server, a bank or cluster of such devices, and the like.

In one example, the access networks 122 may also be in communication with one or more servers 116 and one or more databases (DBs) 118. The server(s) 116 and DB(s) 118 may comprise or be associated with, for example, one or more geographic information systems (GIS)s, e.g., one or more map sources and/or one or more aerial image sources. In one example, DB(s) 118 may comprise physical storage device(s) integrated with server(s) 116 (e.g., a database servers), or attached or coupled to the server(s) 116. For instance, DB(s) 118 may store and provide one or more map databases, such as the United States Geological Survey (USGS) National Transportation Dataset (NTD), ArcGIS, HERE map database, and so forth. In one example, such databases may include or comprise a digital elevation model (DEM), which may comprise a set of raster files or other format files, that records elevations for a set of given points (latitude, longitude). Similarly, DB(s) 118 may store and provide aerial image data, which may include satellite images and/or aerial vehicle-obtained images.

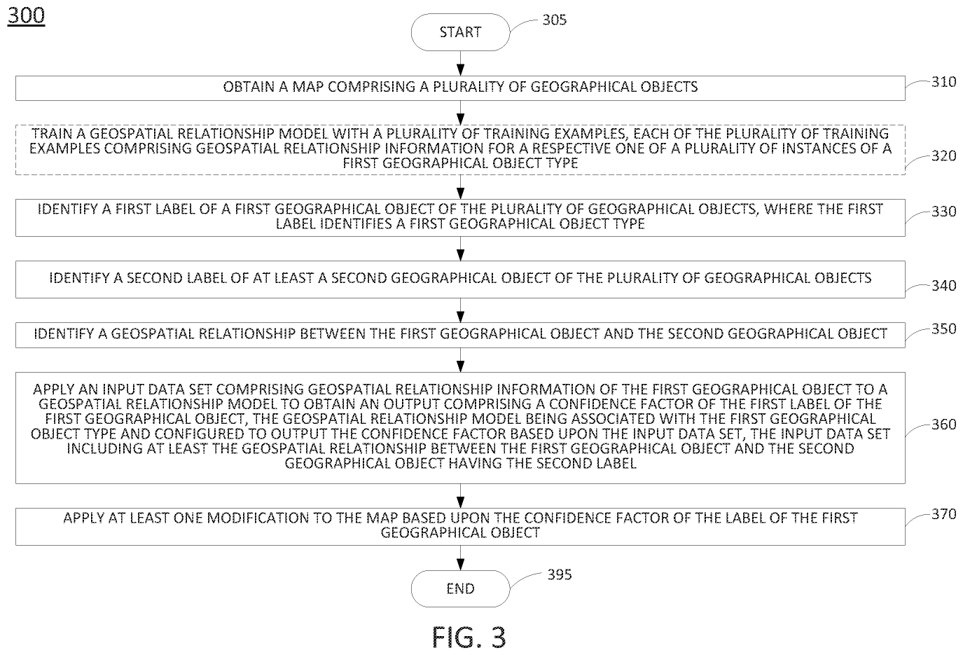

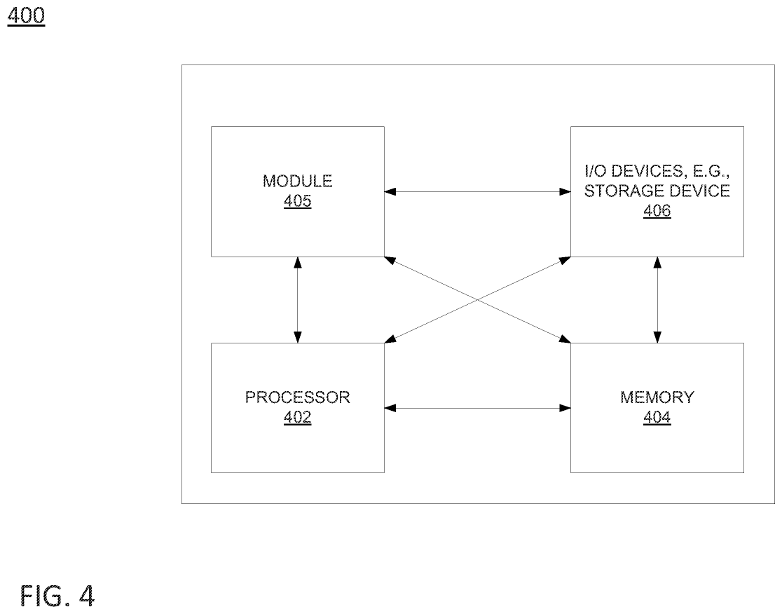

In one example, telecommunication network 102 may also include an application server (AS) 104 and one or more databases (DBs) 106. In one example, the application server 104 may comprise a computing device or processing system, such as computing system 400 depicted in FIG. 4, and may be configured to perform one or more steps, functions, or operations for applying an input data set comprising geospatial relationship information of a first geographical object to a geospatial relationship model to obtain an output comprising a confidence factor of a first label of the first geographical object in a map and applying at least one modification to the map based upon the confidence factor. For instance, an example method for applying an input data set comprising geospatial relationship information of a first geographical object to a geospatial relationship model to obtain an output comprising a confidence factor of a first label of the first geographical object in a map and applying at least one modification to the map based upon the confidence factor is illustrated in FIG. 3 and described below. In addition, it should be noted that as used herein, the terms “configure,” and “reconfigure” may refer to programming or loading a processing system with computer-readable/computer-executable instructions, code, and/or programs, e.g., in a distributed or non-distributed memory, which when executed by a processor, or processors, of the processing system within a same device or within distributed devices, may cause the processing system to perform various functions. Such terms may also encompass providing variables, data values, tables, objects, or other data structures or the like which may cause a processing system executing computer-readable instructions, code, and/or programs to function differently depending upon the values of the variables or other data structures that are provided. As referred to herein a “processing system” may comprise a computing device, or computing system, including one or more processors, or cores (e.g., as illustrated in FIG. 4 and discussed below) or multiple computing devices collectively configured to perform various steps, functions, and/or operations in accordance with the present disclosure.

In one example, DB(s) 106 may comprise physical storage device(s) integrated with AS 104 (e.g., a database server), or attached or coupled to AS 104, to store various types of information in support of systems for applying an input data set comprising geospatial relationship information of a first geographical object to a geospatial relationship model to obtain an output comprising a confidence factor of a first label of the first geographical object in a map and applying at least one modification to the map based upon the confidence factor. For instance, DB(s) 106 may obtain and store the same or similar information as DB(s) 118, e.g., maps/map databases. In one example, AS 104 may obtain such information from server(s) 116 and/or DB(s) 118 and may store the information at DB(s) 106. DB(s) 106 may also store an equipment inventory database that asserts to have geographic locations of different equipment items of the telecommunication network 102, access network(s) 120 and/or 122, and so forth. In one example, this information may alternatively or additional comprise a layer of information in a layered map, e.g., along with geographical objects and their labels, in one or more layers, such as a geospatial layer, a network components layer, a NFV layer, and/or a dynamic and static usage layer, etc. For instance, the inventory may comprise or be included in the network components layer. In one example, the geospatial layer of such a map may be composited from a number of different maps and/or aerial image sources.

In one example, DB(s) 106 may also store ML-classifiers/detection models for detecting instances of one or more geographical object types in aerial images (e.g., satellite and/or aerial vehicle-obtained images). For instance, this may include detection models for utility poles, power line towers, cell towers, light poles, railroad tracks, railway stations, trees, etc. As such, these detection models may be accessed by AS 104 and used to detect different instances of geospatial objects of one or more geographical object types in aerial images. DB(s) 106 may also store usage data collected from different network access points, or cell sites within system 100. In addition, DB(s) 106 may store user, customer, and/or subscriber account records which may include information relating to customer identification, endpoint devices associated with accounts, service addresses and/or billing addresses, service charges (e.g., monthly fees, or the like), add-on features, such as international calling plans, added security features, etc., usage data regarding calls, data volume, and so forth.

In accordance with the present disclosure, DB(s) 106 may also store geospatial relationship models, each associated with a different geographical object type, e.g., a first geospatial relationship model for utility poles, a second geospatial relationship model for cell towers, etc. In one example, AS 104 may access map data of DB(s) 106 and may train the geospatial relationship models in accordance with existing labels for instances of geographical object types. In this regard, AS 104 may obtain geospatial relationship information of such instances via queries over the map/map database in a given zone or area around the each such instance. The geospatial relationship information (e.g., along with the label of the instance) may comprise a training data sample. In one example, AS 104 may also train geospatial object detection/recognition models to detect instances of geospatial object types (e.g., classifiers for utility poles, power line towers, cell towers, light poles, railroad tracks, railway stations, trees, etc.). Alternatively, or in addition, these models may be obtained from other sources and stored in DB(s) 106. In still another example, AS 104 may not detect and apply labels to geospatial objects, but may verify labels after the fact, e.g., where another application server or automated system is tasked with detecting and recognizing instances of different types of geospatial objects and adding labels to the map.

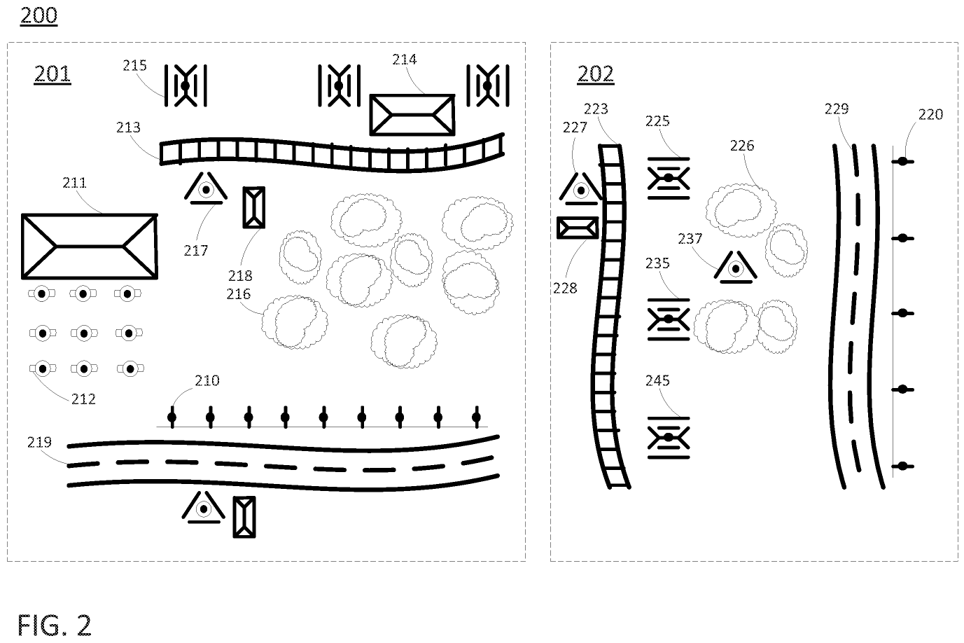

FIG. 2 discussed in greater detail below, illustrates aspects of an example map from which AS 104 may learn geospatial relationships of instances of one or more geographical object types, train geospatial relationship models for the one or more geographical object types, and apply such models to verify or correct map labels relating to instances of the one or more geographical object types in the map.

The foregoing illustrates just one example of a system in which examples of the present disclosure for applying an input data set comprising geospatial relationship information of a first geographical object to a geospatial relationship model to obtain an output comprising a confidence factor of a first label of the first geographical object in a map and applying at least one modification to the map based upon the confidence factor may operate. It should also be noted that the system 100 has been simplified. Thus, the system 100 may be implemented in a different form than that which is illustrated in FIG. 1, or may be expanded by including additional endpoint devices, access networks, network elements, application servers, etc. without altering the scope of the present disclosure. In addition, system 100 may be altered to omit various elements, substitute elements for devices that perform the same or similar functions, combine elements that are illustrated as separate devices, and/or implement network elements as functions that are spread across several devices that operate collectively as the respective network elements. For example, the system 100 may include other network elements (not shown) such as border elements, routers, switches, policy servers, security devices, gateways, a content distribution network (CDN) and the like. For example, portions of telecommunication network 102 and/or access networks 120 and 122 may comprise a content distribution network (CDN) having ingest servers, edge servers, and the like. Similarly, although only two access networks 120 and 122 are shown, in other examples, access networks 120 and/or 122 may each comprise a plurality of different access networks that may interface with telecommunication network 102 independently or in a chained manner. For example, device 113 and server 116 may access telecommunication network 102 via different access networks, devices 110 and 112 may access telecommunication network 102 via different access networks, and so forth. Thus, these and other modifications are all contemplated within the scope of the present disclosure.

FIG. 2 illustrates an example map 200 relating to examples of the present disclosure for applying an input data set comprising geospatial relationship information of a first geographical object to a geospatial relationship model to obtain an output comprising a confidence factor of a first label of the first geographical object in a map and applying at least one modification to the map based upon the confidence factor. The examples of FIG. 2 may relate the same components as illustrated in FIG. 1 and discussed above. For instance, operations described in connection with FIG. 2 may be performed by application server (AS) 104, or the like. As illustrated in FIG. 2, the map 200 may be divided into two portions, training portion 201, and investigation portion 202. For instance, the training portion 201 may be used to extract geospatial relationships for several types of geographical objects that may be used as training data for one or more geospatial relationship models. To illustrate, the training portion 201 includes various geographical objects, which may have been previously detected/recognized and labeled through one or more prior processes (e.g., AS 104 of FIG. 1, or a different processing system may have previously applied various geographical object detection models to the map 200). In another example, AS 104 of FIG. 1 may apply geographical object detection models (e.g., which may be stored in DB(s) 106) to the map 200 to identify and label the various geographical objects. The geographical objects may include a shopping mall 211, light posts 212 (e.g., in a parking lot of the shopping mall 211), railway tracks 213, train station 214, power line towers 215, trees 216, cell towers 217, equipment shed 218, roadway 219, and utility poles 210. It should be noted that although multiple instances of one or more of these different types of geographical objects may be located in the training portion, for illustrated purposes only one of each is labeled. However, it should be understood that each instance of each type of geographical object may be recognized as such and may possess a corresponding label in the map 200.

In one example, geographical objects in the investigation portion 202 may be similarly detected and labeled as such (e.g., railway tracks 223, power line towers 225, 235, and 245, trees 226, cell towers 227 and 237, equipment shed 228, roadway 229, and utility poles 220). It should also be noted that for illustrative purposes, some geographical objects in the investigation portion are not specifically labeled. However, it should be understood that each instance of each type of geographical object may be recognized as such and may possess a corresponding label in the map 200. Nevertheless, as discussed below, one or more of these labels may be incorrect, the likelihood of which may be quantified via the outputs of one or more geospatial relationship models.

For instance, to create a geospatial relationship model for geographical object type of “shopping mall,” shopping mall 211 may be considered as a training example. To obtain the training data, AS 104 may query the map 200 (e.g., a map database) to extract geospatial relationships of shopping mall 211. For instance, the query may return the results of light posts 212 as co-occurrences with the shopping mall 211. There may be similar results of “parking lot” (not shown), roadway (e.g., roadway 219), etc. In one example, AS 104 may perform a similar process with regard to other instances of shopping malls that may be present in the training portion 201. Each example may comprise a training data sample that may be used to train the geospatial relationship model. Accordingly, the geospatial relationship model may learn patterns of geospatial relationships which tend to indicate or be associated with shopping malls (or those that are counter-indicative). When applied to a new example of a geographical object that may or may not be a shopping mall, the output of the geospatial relationship model may be a confidence score of whether or not the geographical object is or is not a shopping mall.

In a similar way, AS 104 may extract geospatial relationships of light posts, such as light posts 212. In one example, for each such light post 212, the geospatial relationships may include a proximity to a shopping mall (e.g., shopping mall 211), as well as proximity to other instances of light posts 212. In addition, in one example, the geospatial relationships of one of the instances of light posts 212 may be a geospatial pattern with other light posts. For instance, it can be seen that light posts 212 are deployed in substantially a grid pattern (which may be relatively evenly distributed throughout a parking lot). These geospatial relationships may be collected for each of a plurality of examples of light posts 212 (or other light posts) and used as training examples for training a geospatial relationship model for “light posts.” It should be noted that in each of these examples, exhaustive lists of possible geospatial relationships are not provided. However, it should be understood that numerous different geospatial relationships may be found for each instance of each of these geospatial object types. In many cases geospatial relationships may be coincidental. However, over a sufficiently large set of training examples, certain definitive patterns in geospatial relationships may be discovered and learned by the respective geospatial relationship models.

In yet another example, AS 104 may extract geospatial relationships of trees, such as trees 216. In one example, for each such tree 216, the geospatial relationships may include a proximity to other instances of trees 216. In addition, in one example, the geospatial relationships of one of the instances of trees 216 may be a geospatial pattern with others of the trees 216 (e.g., in a relatively close grouping with a substantially random layout). Again, these geospatial relationships may be collected for each of a plurality of examples of trees 216 (or other trees) and used as training examples for training a geospatial relationship model for “trees.” In another example, AS 104 may extract geospatial relationships of power line towers 215, which may include (for each such power line tower 215) a proximity, e.g., co-occurrence, with railway tracks 213, as well as a pattern with each other, e.g., relatively uniform/linear spacing along a same right-of-way as the railway tracks 213. As in the previous examples, geospatial relationships may be collected for each of a plurality of examples of power line towers 215 (or other power line towers) and used as training examples for training a geospatial relationship model for “power line towers.” Likewise, AS 104 may extract geospatial relationships of train station 214 (and similarly for other instances of train stations in the training portion 201 (not shown)), to train a geospatial relationship model for “train station.” These may include co-occurrence, e.g., proximity, adjacency, etc. with railway tracks 213.

In still another example, AS 104 may extract geospatial relationships of utility poles 210 (and/or other utility poles (not shown)), to train a geospatial relationship model for “utility pole.” For each utility pole 210, these may include co-occurrence, e.g., proximity, adjacency, etc. with roadway 219, as well as co-occurrence with other instances of utility poles 210. In one example, geospatial relationships of utility poles 210 may also include a pattern with each other, e.g., relatively uniform/linear spacing, such as every 125 feet, on average, etc. To further illustrate, AS 104 may extract geospatial relationships of cell towers 217 (and/or other cell towers (not shown)), to train a geospatial relationship model for “cell tower.” For one of the cell towers 217, this may include co-occurrence, e.g., proximity/adjacency to railway tracks 213. For another of the cell towers 217 the geospatial relationships may include co-occurrence, e.g., proximity/adjacency to roadway 219. For both of cell towers 217 illustrated in FIG. 1, the geospatial relationships may further include co-occurrence, e.g., proximity/adjacency to utility sheds 218. Qualitatively, the geospatial relationship model for “cell tower” may expect or prefer a utility shed nearby to each such instance of a cell tower as well as some type of nearby transportation feature, e.g., a road, railway tracks, etc. Thus, the geospatial relationship model may not specifically favor or expect a railway track to be nearby, in contrast to the geospatial relationship model for “train station,” which may more strongly favor and expect railway lines to be a co-occurrence (e.g., to be adjacent to a geospatial object labeled as “train station”).

Turning now to the investigation portion 202, as noted above, in one example, the geospatial objects and their types may be included in the map 200 as these features are obtained from one or more map sources/map data sources, may be added by human labelers, and/or may be discovered/learned via various ML-detection models associated with the respective types of geospatial objects. In accordance with the present disclosure, geospatial relationship models, such as trained/generated in accordance with the training portion 201, may be applied, e.g., to instances of geospatial objects in investigation portion 202, to confirm classification/label accuracy and/or to identify possible mislabels/misclassifications.

To illustrate, AS 104 may investigate the geospatial object labeled as power line tower 225. For instance, AS 104 may extract geospatial relationships of the purported power line tower 225 from the map 200. For instance, the map 200 (or underlying map database) may be queryable in accordance with PostGIS and/or PostgreSQL. The querying may be automatic in accordance with examples of the present disclosure to search for particular types of geospatial relationships. For power line tower 225, the query(ing) may return geospatial relationships of co-occurrence, e.g., proximity and/or adjacency to railway tracks 223, as well as co-occurrence, e.g., proximity to at least one other power line tower 235. In addition, the query(ing) may return a geospatial relationship comprising a pattern of power line tower 225, with other power line towers 235 and 245 (etc.), e.g., relatively uniform/linear spacing along a same right-of-way as the railway tracks 223. These and other geospatial relationships may be input to the geospatial relationship model for “power line tower,” which may output a confidence factor indicative of the likelihood that the geospatial object is or is not a power line tower. In this case, the output may be a positive confidence factor (or non-negative confidence factor) due to the co-location of railway tracks 223 and the geospatial pattern with the other power line towers 235 and 245.

In a next example, AS 104 may investigate cell tower 227 (e.g., the geospatial object labeled as such). For instance, AS 104 may extract geospatial relationships of the purported cell tower 227 from the map 200, which may include co-occurrence, e.g., proximity and/or adjacency to railway tracks 223, as well as co-occurrence, e.g., proximity and/or adjacency to utility shed 228. These geospatial relationships (and in one example, additional geospatial relationships) may be input to the geospatial relationship model for “cell tower,” which may output a confidence factor indicative of the likelihood that the geospatial object is or is not a cell tower. In this case, the output may again be a positive confidence factor (or non-negative confidence factor) due to the co-location of railway tracks 223 and the co-location of utility shed 228.

In a third example, AS 104 may investigate a geospatial object labeled as a utility pole 220. In this case, the geospatial relationships extracted may include a co-occurrence, e.g., proximity/adjacency to roadway 229, proximity to one or more other utility poles, and a geospatial pattern with other utility poles, e.g., relatively uniform/linear spacing (along roadway 229). These geospatial relationships (and in one example, additional geospatial relationships) may be input to the geospatial relationship model for “utility pole,” which may output a confidence factor indicative of the likelihood that the geospatial object is or is not a utility pole. In this case, the output may again be a positive confidence factor (or non-negative confidence factor) due to the co-location of roadway 229 and the geospatial pattern with the other utility poles 220. It should be noted that the spacing of utility poles 220 may be different from the spacing of utility poles 210. However, the geospatial relationship model for “utility pole” may not learn or favor a precise spacing, but may learn, over various training examples, a general pattern of repetitive spacing along roadways. Thus, the geospatial relationship model may flexibly consider and weight similar repetitive spacing patterns, regardless of the precise spacing distances.

In still another example, AS 104 may investigate a geospatial object labeled as a cell tower 237, e.g., extracting geospatial relationships, which may include co-occurrence, e.g., proximity/adjacency to various trees 226, and applying the geospatial relationships as an input data set to the geospatial relationship model for “cell tower,” which may output a confidence factor indicative of the likelihood that the geospatial object is or is not a cell tower. In this case, the output may be a negative confidence factor, which may be due to co-location of numerous trees 226, the lack of co-occurrence/co-location of a transportation feature (e.g., railway tracks and/or a roadway, etc.), the lack of co-occurrence of a utility shed, a combination of any or all of these factors and/or others, e.g., depending upon the configuration and training of the geospatial relationship model for “cell tower.”

FIG. 3 illustrates a flowchart of an example method 300 for applying an input data set comprising geospatial relationship information of a first geographical object to a geospatial relationship model to obtain an output comprising a confidence factor of a first label of the first geographical object in a map and applying at least one modification to the map based upon the confidence factor. In one example, the method 300 is performed by a component of the system 100 of FIG. 1, such as by application server 104, and/or any one or more components thereof (e.g., a processor, or processors, performing operations stored in and loaded from a memory), or by application server 104, in conjunction with one or more other devices, such as DB(s) 106, server(s) 116, DB(s) 118, devices 110-113, and so forth. In one example, the steps, functions, or operations of method 300 may be performed by a computing device or system 400, and/or processor 402 as described in connection with FIG. 4 below. For instance, the computing device or system 400 may represent any one or more components of application server 104, and so forth in FIG. 1 that is/are configured to perform the steps, functions and/or operations of the method 300. Similarly, in one example, the steps, functions, or operations of method 300 may be performed by a processing system comprising one or more computing devices collectively configured to perform various steps, functions, and/or operations of the method 300. For instance, multiple instances of the computing device or processing system 400 may collectively function as a processing system. For illustrative purposes, the method 300 is described in greater detail below in connection with an example performed by a processing system. The method 300 begins in step 305 and proceeds to step 310.

At step 310, the processing system obtains a map comprising a plurality of geographical objects.

At optional step 320, the processing system trains a geospatial relationship model with a plurality of training examples, each of the plurality of training examples comprising geospatial relationship information for a respective one of a plurality of instances of a first geographical object type (and in one example, for a plurality of different geographical object types). For instance, each of the plurality of training examples may be obtained from at least one of: the map, or one or more other maps. The geospatial relationship mode may comprise, for instance, a deep neural network (DNN), a convolutional neural network (CNN), a kernel-based classifier, a support vector machine (SVM), and so forth. The geospatial relationship information may comprise, for each instance of the plurality of instances of the first geographical object type, co-occurrences of the instance of the first geographical object type with one or more instances of other geographical object types within a threshold distance from the instance of the first geographical object type. Other types of geospatial relationship information may comprise co-occurrences of the instance of the first geographical object type with one or more others of the plurality of instances of the first geographical object type within a threshold distance from the instance of the first geographical object type (e.g., if there are light poles in parking lot, there are probably others nearby), co-occurrences of the instance of the first geographical object type with one or more instances of other geographical object types contiguous to the instance of the first geographical object type (e.g., a cell tower is often accompanied by a shed with generator, base station equipment, etc.), co-occurrences of the instance of the first geographical object type with one or more others of the plurality of instances of the first geographical object type contiguous to the instance of the first geographical object type (e.g., if there are trees, then it is likely that there are more trees nearby), and so forth. In one example, the geospatial relationship information may further comprise distances relating to some or all of the above types of geospatial relationship information. In one example, geospatial relationship information may also comprise, for at least one instance of the plurality of instances of the first geographical object type, a geospatial pattern of the at least one instance together with other instances of the plurality of instances of the first geographical object type. This could include a repeating pattern on the map and/or in aerial images, e.g., evenly spaced light poles, power lines, etc., (e.g., in a linear, or substantially linear pattern). In one example, this type of geospatial pattern may further comprise a co-occurrence of at least one instance of at least one other geographical object type with the repeating pattern in the map. For instance, light poles spaced at regular intervals along a road, power lines spaced evenly along a fire cut/gap in the forest, at regular intervals coincident with train tracks, etc., may be considered as a geospatial relationship.

At step 330, the processing system identifies a first label of a first geographical object of the plurality of geographical objects, where the first label identifies a first geographical object type. In one example, the first label of the first geographical object of the plurality of geographical objects is identified from the map. In particular, the first label of the first geographical object of the plurality of geographical objects may be stored in the map. In another example, step 330 may include applying at least one of the map or an aerial image representing a same geographical area as the map to at least one object detection model. For instance, the at least one object detection model may comprise a first object detection model for detecting geographical objects of the first geographical object type (e.g., where the first geographical object is of the first geographical object type). In one example, the first object detection model is to output a confidence score associated with the first label of the first geographical object that is determined via the first object detection model.

At step 340, the processing system identifies a second label of at least a second geographical object of the plurality of geographical objects. For instance, step 340 may comprise similar operations as discussed with respect to step 330.

At step 350, the processing system identifies a geospatial relationship between the first geographical object and the second geographical object.

At step 360, the processing system applies an input data set comprising geospatial relationship information of the first geographical object to a geospatial relationship model to obtain an output comprising a confidence factor of the first label of the first geographical object. For example, the geospatial relationship model may be associated with the first geographical object type and is to output the confidence factor based upon the input data set comprising the geospatial relationship information of the first geographical object (e.g., where the input data set includes at least the geospatial relationship between the first geographical object and the second geographical object having the second label).

At step 370, the processing system applies at least one modification to the map based upon the confidence factor of the label of the first geographical object. For instance, the at least one modification may comprise adjusting, in accordance with the confidence factor, a confidence score of the first label of the first geographical object that is stored in the map. For instance, as discussed above, the confidence score may be stored in the map in association with the first label of the first geographical object. In another example, the at least one modification may alternatively or additionally comprise applying a visual indicator to the first geographical object that is stored in the map, where the visual indicator is associated with confidence factor. For instance, the visual indicator may comprise at least one of: a highlighting, an icon (such as an arrow, and or a different icon for different confidence factors or confidence factor bands), a modified color of the first geographical object, an outline of the first geographical object, a repetitive lighting or coloring pattern modification of the first geographical object, a repetitive lighting or coloring pattern of an icon over at least a portion of the first geographical object, etc. For example, the visual indicator may be presented when a portion of the map including the first geographical object is displayed via a user device.

In an example where the map does not yet include a label and confidence score for the first geographical object (e.g., where step 330 includes classifying the first geographical object as being an instance of the first geographical object type via the at least one object detection model), step 370 may include adding the first label of the first geographical object to the map in association with the first geographical object. In one example, the first label of the first geographical object is added to the map when the confidence factor exceeds a threshold value, e.g., as long as there is not a negative confidence factor, or if it is not strongly negative (and conversely may not be added if and when the confidence factor does not meet the threshold). As noted above in connection with step 330, in one example, the first object detection model may be configured to output a confidence score associated with the first label of the first geographical object that is determined via the first object detection model. In such case, the at least one modification of step 360 may further comprise adjusting, in accordance with the confidence factor, the confidence score of the first label of the first geographical object, and storing in the map, in association with the first label, the confidence score that is adjusted.

Following step 370, the method 300 proceeds to step 395 where the method 300 ends.

It should be noted that the method 300 may be expanded to include additional steps, or may be modified to replace steps with different steps, to combine steps, to omit steps, to perform steps in a different order, and so forth. For instance, in one example the processing system may repeat one or more steps of the method 300 for additional geographical objects in the map. In another example, the method 300 may include generating the map, e.g., in one or more layers comprising a composition of different source maps, map databases, and/or other geospatial data from one or more source databases (e.g., a telecommunication network inventory/equipment database, or the like), from one or more aerial images, and so forth. In one example, the method 300 may be expanded or modified to include additional, other, further, and/or different steps, functions, and/or operations as described elsewhere herein. Thus, these and other modifications are all contemplated within the scope of the present disclosure.

In addition, although not expressly specified above, one or more steps of the method 300 may include a storing, displaying and/or outputting step as required for a particular application. In other words, any data, records, fields, and/or intermediate results discussed in the method(s) can be stored, displayed and/or outputted to another device as required for a particular application. Furthermore, operations, steps, or blocks in FIG. 3 that recite a determining operation or involve a decision do not necessarily require that both branches of the determining operation be practiced. In other words, one of the branches of the determining operation can be deemed as an optional step. Furthermore, operations, steps or blocks of the above described method(s) can be combined, separated, and/or performed in a different order from that described above, without departing from the example embodiments of the present disclosure.

FIG. 4 depicts a high-level block diagram of a computing device or processing system specifically programmed to perform the functions described herein. For example, any one or more components or devices illustrated in FIG. 1 or described in connection with the example map 200 of FIG. 2 or the example method 300 of FIG. 3 may be implemented as the processing system 400. As depicted in FIG. 4, the processing system 400 comprises one or more hardware processor elements 402 (e.g., a microprocessor, a central processing unit (CPU) and the like), a memory 404, (e.g., random access memory (RAM), read only memory (ROM), a disk drive, an optical drive, a magnetic drive, and/or a Universal Serial Bus (USB) drive), a module 405 for applying an input data set comprising geospatial relationship information of a first geographical object to a geospatial relationship model to obtain an output comprising a confidence factor of a first label of the first geographical object in a map and applying at least one modification to the map based upon the confidence factor, and various input/output devices 406, e.g., a camera, a video camera, storage devices, including but not limited to, a tape drive, a floppy drive, a hard disk drive or a compact disk drive, a receiver, a transmitter, a speaker, a display, a speech synthesizer, an output port, and a user input device (such as a keyboard, a keypad, a mouse, and the like).

Although only one processor element is shown, it should be noted that the computing device may employ a plurality of processor elements. Furthermore, although only one computing device is shown in the Figure, if the method(s) as discussed above is implemented in a distributed or parallel manner for a particular illustrative example, i.e., the steps of the above method(s) or the entire method(s) are implemented across multiple or parallel computing devices, e.g., a processing system, then the computing device of this Figure is intended to represent each of those multiple computing devices. Furthermore, one or more hardware processors can be utilized in supporting a virtualized or shared computing environment. The virtualized computing environment may support one or more virtual machines representing computers, servers, or other computing devices. In such virtualized virtual machines, hardware components such as hardware processors and computer-readable storage devices may be virtualized or logically represented. The hardware processor 402 can also be configured or programmed to cause other devices to perform one or more operations as discussed above. In other words, the hardware processor 402 may serve the function of a central controller directing other devices to perform the one or more operations as discussed above.

It should be noted that the present disclosure can be implemented in software and/or in a combination of software and hardware, e.g., using application specific integrated circuits (ASIC), a programmable logic array (PLA), including a field-programmable gate array (FPGA), or a state machine deployed on a hardware device, a computing device, or any other hardware equivalents, e.g., computer readable instructions pertaining to the method(s) discussed above can be used to configure a hardware processor to perform the steps, functions and/or operations of the above disclosed method(s). In one example, instructions and data for the present module or process 405 for applying an input data set comprising geospatial relationship information of a first geographical object to a geospatial relationship model to obtain an output comprising a confidence factor of a first label of the first geographical object in a map and applying at least one modification to the map based upon the confidence factor (e.g., a software program comprising computer-executable instructions) can be loaded into memory 404 and executed by hardware processor element 402 to implement the steps, functions or operations as discussed above in connection with the example method 300. Furthermore, when a hardware processor executes instructions to perform “operations,” this could include the hardware processor performing the operations directly and/or facilitating, directing, or cooperating with another hardware device or component (e.g., a co-processor and the like) to perform the operations.

The processor executing the computer readable or software instructions relating to the above described method(s) can be perceived as a programmed processor or a specialized processor. As such, the present module 405 for applying an input data set comprising geospatial relationship information of a first geographical object to a geospatial relationship model to obtain an output comprising a confidence factor of a first label of the first geographical object in a map and applying at least one modification to the map based upon the confidence factor (including associated data structures) of the present disclosure can be stored on a tangible or physical (broadly non-transitory) computer-readable storage device or medium, e.g., volatile memory, non-volatile memory, ROM memory, RAM memory, magnetic or optical drive, device or diskette and the like. Furthermore, a “tangible” computer-readable storage device or medium comprises a physical device, a hardware device, or a device that is discernible by the touch. More specifically, the computer-readable storage device may comprise any physical devices that provide the ability to store information such as data and/or instructions to be accessed by a processor or a computing device such as a computer or an application server.

While various embodiments have been described above, it should be understood that they have been presented by way of example only, and not limitation. Thus, the breadth and scope of a preferred embodiment should not be limited by any of the above-described example embodiments, but should be defined only in accordance with the following claims and their equivalents.

What is claimed is:

1. A method comprising:
obtaining, by a processing system including at least one processor, a map comprising a plurality of geographical objects;
identifying, by the processing system, a first label of a first geographical object of the plurality of geographical objects, wherein the first label identifies a first geographical object type;
identifying, by the processing system, a second label of at least a second geographical object of the plurality of geographical objects;
identifying, by the processing system, a geospatial relationship between the first geographical object and the second geographical object;
applying, by the processing system, an input data set comprising geospatial relationship information of the first geographical object to a geospatial relationship model to obtain an output comprising a confidence factor of the first label of the first geographical object, wherein the geospatial relationship model is associated with the first geographical object type and is to output the confidence factor based upon the input data set comprising the geospatial relationship information of the first geographical object, wherein the input data set includes at least the geospatial relationship between the first geographical object and the second geographical object having the second label; and
applying, by the processing system, at least one modification to the map based upon the confidence factor of the label of the first geographical object.

2. The method of claim 1, wherein the at least one modification comprises:
adjusting, in accordance with the confidence factor, a confidence score of the first label of the first geographical object that is stored in the map, wherein the confidence score is stored in the map in association with the first label of the first geographical object.

3. The method of claim 2, wherein the confidence score is displayed on the map via a user interface in accordance with a user selection.

4. The method of claim 1, wherein the at least one modification comprises:
applying a visual indicator to the first geographical object that is stored in the map, the visual indicator associated with the confidence factor.

5. The method of claim 4, wherein the visual indicator comprises at least one of:
a highlighting;
an icon;
a modified color of the first geographical object;
an outline of the first geographical object;
a repetitive lighting or coloring pattern modification of the first geographical object; or
a repetitive lighting or coloring pattern of an icon over at least a portion of the first geographical object.

6. The method of claim 1, wherein the first label of the first geographical object of the plurality of geographical objects is identified from the map, wherein the first label of the first geographical object of the plurality of geographical objects is stored in the map.

7. The method of claim 1, wherein the identifying the label of the first geographical object comprises:
applying at least one of the map or an aerial image representing a same geographical area as the map to at least one object detection model, wherein the at least one object detection model comprises a first object detection model for detecting geographical objects of the first geographical object type, wherein the first geographical object is of the first geographical object type.

8. The method of claim 7, wherein the at least one modification comprises:
adding the first label of the first geographical object to the map in association with the first geographical object.

9. The method of claim 8, wherein the first label of the first geographical object is added to the map when the confidence factor exceeds a threshold value.

10. The method of claim 8, wherein the first object detection model is to output a confidence score associated with the first label of the first geographical object that is determined via the first object detection model, wherein the at least one modification further comprises:
adjusting, in accordance with the confidence factor, the confidence score of the first label of the first geographical object; and
storing in the map, in association with the first label, the confidence score that is adjusted.

11. The method of claim 1, wherein the geospatial relationship model comprises:
a deep neural network;
a convolutional neural network;
a kernel-based classifier; or
a support vector machine.

12. The method of claim 1, further comprising:
training the geospatial relationship model with a plurality of training examples, each of the plurality of training examples comprising geospatial relationship information for a respective one of a plurality of instances of the first geographical object type.

13. The method of claim 12, wherein each of the plurality of training examples is obtained from at least one of:
the map; or
one or more other maps.

14. The method of claim 12, wherein the geospatial relationship information comprises, for each instance of the plurality of instances of the first geographical object type, at least one of:
co-occurrences of the instance of the first geographical object type with one or more instances of other geographical object types within a threshold distance from the instance of the first geographical object type; or
co-occurrences of the instance of the first geographical object type with one or more others of the plurality of instances of the first geographical object type within a threshold distance from the instance of the first geographical object type.

15. The method of claim 12, wherein the geospatial relationship information comprises, for each instance of the plurality of instances of the first geographical object type, at least one of:
co-occurrences of the instance of the first geographical object type with one or more instances of other geographical object types contiguous to the instance of the first geographical object type; or
co-occurrences of the instance of the first geographical object type with one or more others of the plurality of instances of the first geographical object type contiguous to the instance of the first geographical object type.

16. The method of claim 12, wherein the geospatial relationship information comprises, for at least one instance of the plurality of instances of the first geographical object type, a geospatial pattern of the at least one instance with other instances of the plurality of instances of the first geographical object type.

17. The method of claim 16, wherein the geospatial pattern comprises a repeating pattern in the map.

18. The method of claim 17, wherein the geospatial pattern further comprises a co-occurrence of at least one instance of at least one other geographical object type with the repeating pattern in the map.

19. A non-transitory computer-readable medium storing instructions which, when executed by a processing system including at least one processor, cause the processing system to perform operations, the operations comprising:
obtaining a map comprising a plurality of geographical objects;
identifying a first label of a first geographical object of the plurality of geographical objects, wherein the first label identifies a first geographical object type;
identifying a second label of at least a second geographical object of the plurality of geographical objects;
identifying a geospatial relationship between the first geographical object and the second geographical object;
applying an input data set comprising geospatial relationship information of the first geographical object to a geospatial relationship model to obtain an output comprising a confidence factor of the first label of the first geographical object, wherein the geospatial relationship model is associated with the first geographical object type and is to output the confidence factor based upon the input data set comprising the geospatial relationship information of the first geographical object, wherein the input data set includes at least the geospatial relationship between the first geographical object and the second geographical object having the second label; and
applying at least one modification to the map based upon the confidence factor of the label of the first geographical object.

20. An apparatus comprising:
a processing system including at least one processor; and
a computer-readable medium storing instructions which, when executed by the processing system, cause the processing system to perform operations, the operations comprising:
obtaining a map comprising a plurality of geographical objects;
identifying a first label of a first geographical object of the plurality of geographical objects, wherein the first label identifies a first geographical object type;
identifying a second label of at least a second geographical object of the plurality of geographical objects;
identifying a geospatial relationship between the first geographical object and the second geographical object;
applying an input data set comprising geospatial relationship information of the first geographical object to a geospatial relationship model to obtain an output comprising a confidence factor of the first label of the first geographical object, wherein the geospatial relationship model is associated with the first geographical object type and is to output the confidence factor based upon the input data set comprising the geospatial relationship information of the first geographical object, wherein the input data set includes at least the geospatial relationship between the first geographical object and the second geographical object having the second label; and
applying at least one modification to the map based upon the confidence factor of the label of the first geographical object.
